(19) United States
(12) Patent Application Publication
(10) Pub. No.: US 2006/0052120 A1
(43) Pub. Date: Mar. 9, 2006

(54) Communication terminal

(75) Inventors: Walter Kodim, Stein (DE); Dan Dinescu, Munich (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/218,315

(22) Filed: Aug. 31, 2005

Related U.S. Application Data
(60) Provisional application No. 60/606,259, filed on Sep. 1, 2004.

(30) Foreign Application Priority Data
Sep. 1, 2004 (DE) 102004042329.6-31
Nov. 30, 2004 (DE) 10 2004 057 784.6

(51) Int. Cl. H04Q 7/20

(52) U.S. Cl. 455/466; 455/412.1; 455/404.1

(57) ABSTRACT

A device coupled to a communication terminal allows an emergency sequence to be triggered. During the emergency sequence, the communication terminal outputs a signal, so that, by way of example, a voice link is set up to a prescribed telephone number. The external triggering apparatus is in the form of a memory card, for example, which has a triggering grip and is coupled to the communication terminal by means of a card reading apparatus.

### CROSS-REFERENCE TO RELATED APPLICATION

This application claims priority to Provisional Patent Application Ser. No. 60/606,259, which was filed on Sep. 1, 2004, German Patent Application Serial No. 10 2004 042 329.6-31, which was filed on Sep. 1, 2004, and German Patent Application No. 10 2004 057 784.6, which was filed on Nov. 20, 2004. Each of these application is incorporated herein by reference in their entireties.

### FIELD OF THE INVENTION

The invention relates to communication terminals, methods for controlling a communication terminal, communication arrangements, a triggering apparatus, computer program elements and a computer readable storage medium.

### BACKGROUND OF THE INVENTION

Mobile radio telephones are a suitable and widespread means for requesting help and support in an emergency situation, regardless of whether the emergency situation arises in road traffic, in coastal regions or in mountain regions, as described in “Das Netz, das Leben rettet” [The network which saves lives]; Sudhessische Post, 01.25.2003, for example.

In line with the GSM (Global System for Mobile Communications) standard for mobile radio communication systems, which is described in Michel Mouly, Marie-Bernadette Pautet, “The GSM system for Mobile Communications”, ISBN 2 9507190 0 7, 1992, for example, the emergency call is provided as a special communication service which allows a user of a mobile radio user terminal to reach an emergency service nearby using a simple and standardized method by dialing the number 112. This number has been decreed as the standard emergency number for Europe and is equivalent to the emergency number 911 in the USA.

An emergency situation can be characterized in the following manner:
support and help from a second party is required;
the time before a response must be short;
either the person in need of help calls for help or helpers who are at an emergency location call for help.

In the conventional emergency call method, at least three keys on the mobile radio user terminal intended to be used to make an emergency call need to be operated, provided that the mobile radio user terminal is already turned on. There then follows a short conversation in which the situation is explained.

However, this emergency call method has various restrictions. By way of example, someone wearing gloves, for example a snowboarder, might have difficulty in taking the mobile radio user terminal and operating relatively small keys.

In addition, the telephone numbers 112 and 911 are fixed telephone numbers and are reserved for telephone calls, that is to say that they cannot be used for nonaudio notification.

A one-touch dialing key for dialing a telephone number is proposed in Product Leaflet, Europorty PR701, Philips Kommunikations Industrie AG, 1994. In this case, an “SOS” key allows rapid dialing of an emergency telephone number.

Further options are known for simplifying the operation of emergency call keys on mobile radio user terminals in various ways. However, typically an implementation which needs to be taken into account in the mechanical and electrical design of the respective mobile radio user terminal is used, for example see DE 29809959 U1, which describes a mobile radio user terminal which is in a form such that it has a special operating element. The respective mobile radio user terminal, or else other emergency call units, is therefore of very specific design and expensive.

On account of the stated drawbacks, the large majority of mobile radio user terminals which are currently in use have no advanced emergency call functionality.

WO 9623385 A1 describes a mobile radio user terminal in which the operation of a key makes an emergency call using a stored police emergency number or a stored medical emergency number and puts the mobile radio user terminal into a constant transmission mode, so that the transmitted signal can be used for locating purposes.

JP 2002056486 A discloses an emergency call system having a portable receiver which is set up to receive an emergency call signal which is transmitted by a portable terminal when an SOS key is operated. In this way, an emergency call signal can also be received when the portable terminal is situated outside of the range of a base station.

FR 2820585 A1 discloses an apparatus having a motion detector which activates a mobile radio user terminal, so that the mobile radio user terminal sets up a communication link to a further mobile radio user terminal.

WO 2003041290 A1 discloses a mobile radio user terminal having an alarm function which has an alarm key whose operation prompts the mobile radio user terminal to output an audio alarm signal.

DE 20302327 U1 discloses a bodyphone which can be worn on the body and outputs an emergency call signal when a switching element is operated.

GB 2360904 A proposes equipping mobile radio user terminals with a depressed emergency call key which is operational even when there is a keylock.

MultiMediaCard Product Manual Rev. 5.2, San Disk Corporation, 2002/2003 describes a memory chip card, the MultiMediaCard.

### SUMMARY OF THE INVENTION

A communication terminal having a detection device, a control device, a signal generation device and a signal output device, where the communication terminal can be coupled to an external triggering apparatus which has an operating element and a signaling device, the signaling device being set up to generate a trigger signal when the operating element is operated mechanically; the detection device is set up to detect the trigger signal; the control device is set up so that when the trigger signal is detected by the detection device it controls the signal generation device and the signal output device such that the signal generation device generates a signal which is output by the signal output device.

### BRIEF DESCRIPTION OF THE DRAWINGS

Exemplary embodiments of the invention are shown in the figures and are explained in more detail below.

FIG. 1 shows a mobile radio user terminal based on an exemplary embodiment of the invention;

FIG. 2 shows a communication arrangement based on an exemplary embodiment of the invention;

FIG. 3 shows a memory chip card based on an exemplary embodiment of the invention;

FIG. 4 shows a memory chip card based on an exemplary embodiment of the invention;

FIG. 5a and FIG. 5b show a switching element in a first state and in a second state based on an exemplary embodiment of the invention;

FIG. 6 shows a chip card reader based on an exemplary embodiment of the invention;

FIG. 7a and FIG. 7b show retaining systems based on an exemplary embodiment of the invention;

FIG. 8 shows a flowchart based on an exemplary embodiment of the invention;

FIG. 9 shows a mobile radio user terminal based on an exemplary embodiment of the invention;

FIG. 10(a) and FIG. 10(b) show accessories based on an exemplary embodiment of the invention;

FIG. 11 shows a memory chip card based on an exemplary embodiment of the invention;

FIG. 12 shows a flowchart based on an exemplary embodiment of the invention;

FIG. 13 shows a flowchart based on an exemplary embodiment of the invention; and

FIG. 14 shows a flowchart based on an exemplary embodiment of the invention.

### DETAILED DESCRIPTION OF PREFERRED EMBODIMENTS OF THE INVENTION

The invention is based on the problem of providing a communication terminal emergency call functionality which is less expensive, more secure and more flexible in comparison with the prior art.

The problem is solved by communication terminals, methods for controlling a communication terminal, communication arrangements, a triggering apparatus, computer program elements and a computer readable storage medium.

A communication terminal having a detection device, a control device, a signal generation device and a signal output device is provided. The communication terminal can be coupled to an external triggering apparatus which has an operating element and a signaling device, the signaling device being set up to generate a trigger signal when the operating element is operated mechanically. The detection device is set up to detect the trigger signal, and the control device is set up so that when the trigger signal is detected by the detection device it controls the signal generation device and the signal output device such that the signal generation device generates a signal which is output by the signal output device.

The invention also provides a method for controlling a communication terminal, a communication arrangement, a triggering apparatus and a computer program element according to the communication terminal described above.

Further, a communication terminal having a control device, a signal generation device and a signal output device is provided, wherein the communication terminal can be coupled with an accessory. The control device is adapted to control the signal generation device and the signal output device dependent on whether the accessory is coupled with the communication terminal in such a way, that the signal generation device generates a signal which is output from the signal output device und from which can be determined if an emergency has occurred.

The invention also provides a method for controlling a communication terminal, a communication arrangement, a computer program element and a computer readable storage medium according to the communication terminal described above.

In one embodiment of the invention, illustratively, a communication terminal is coupled to an apparatus which has an operating element, such as a key or a grip, for easily triggering an emergency call (or an emergency sequence), the apparatus not being part of the communication terminal itself.

This provides a simple and secure opportunity to trigger an emergency call without this opportunity needing to be provided by the communication terminal itself.

In particular, it is not necessary for the communication terminal to be in a special form, but rather the invention can be used with any communication terminal which has an interface for coupling the communication terminal to an external triggering apparatus. Since communication terminals typically have such interfaces, for example a Bluetooth module or an interface for a simple plug connection, the invention can be implemented on the basis of almost any communication terminal.

One idea on which the invention is based may be seen in that a triggering element which can be operated easily and securely even under difficult conditions is provided separately from a communication terminal, with a prescribed sequence (comprising prescribed actions) being performed when the triggering element is operated.

The triggering element is preferably coupled to the communication terminal by means of a standard interface, so that it can be used for a large portion of commercially available communication terminals and so that an advanced emergency call functionality can be provided inexpensively for a large number of communication terminals, for example mobile radio user terminals.

In particular, the invention is not limited to use with specific hardware, for example with one specific mobile platform.

Mechanical operation is to be understood, by way of example, to mean pressing a key, pulling on a grip or triggering a sensor, for example touching a sensor with the finger or pressing a sensor.

Illustratively, the emergency call functionality is provided by means of the triggering apparatus, and the complexity and cost of the communication terminal are thus increased only slightly by providing the advanced emergency call functionality.

In addition, the advanced emergency call functionality can be provided at any time by plugging on the triggering apparatus and setting up the communication terminal appropriately, for example by installing appropriate driver software, and, in particular, does not need to be taken into account during the actual design of the communication terminal.

In comparison with specially designed mobile radio user terminals, an advanced emergency call functionality can therefore be provided less expensively.

In one embodiment, illustratively, the communication terminal checks whether the accessory is coupled to the the communication terminal and accordingly, outputs a emergency signal.

For example, an emergency signal is output when the user of the communication terminal separates the accessory from the communication terminal or when he couples the accessory to the communication terminal.

Since the user only needs to take a simple action for triggering an emergency (e.g. separate the accessory from the communication terminal) a simple and secure way for triggering an emergency is provided in this way and thus, an advanced emergency functionality is provided.

For the advanced emergency functionality of the communication terminal it is not necessary that the communication terminal is formed in a special way, but the invention can be used with any communication terminal which comprises an interface to couple the communication terminal wich an accessory. Since communication terminals usually comprise such interfaces, e.g. a simple socket for a plug connection, the invention can be realized based on almost any communication terminal.

The complexity and the cost of the communication terminal are in particular only slightly increased by the provision of the advanced emergency functionality.

One idea on which the invention is based can be seen in that an emergency function is provided which can also be activated simply and securely under difficult circumstances, for example when the user is wearing thick gloves, wherein when the emergency function is activated, a predetermined flow (comprising predetermined actions) is carried out.

Illustratively, for example a mobile radio user terminal (or another mobile platform) with which the usage of accessories is possible is extended by using a special accessory, such that the mobile radio user terminal comprises an advanced emergency functionality.

Accessory herein means a device which is not absolutely necessary for the central function of the communication terminal, e.g. for voice communication using the communication terminal, for example a memory card, an USB stick, a handsfree set or also a specially formed accessory, as described below.

The accessory is preferably coupled to the communication terminal via a standard interface, such that it can be used for the majority of customary communication terminals und such that an advanced emergency functionality can be provided at low cost for a lot of communication terminals, for example for mobile radio user terminals.

In particular, the invention is not limited to its usage in combination with a special hardware, for example in combination with a special mobile platform.

Further, the advanced emergency functionality can be provided at any time by a corresponding setup of the communication terminal, for example by installing a corresponding driver software and in particular has not to be considered when designing the communication terminal.

Therefore, in comparison to specially formed mobile radio user terminals an advanced emergency functionality can be provided at lower cost.

The other refinements of the invention which are described in connection with one of the communication terminals also apply in appropriate fashion to the other communication terminal, to the methods for controlling the communication terminal, to the communication arrangements, to the triggering apparatus, to the computer program elements and to the computer readable storage media.

It is preferred for the signal to be in a form such that the output of the signal sets up a voice communication link using a telephone number from a plurality of prescribed telephone numbers and/or such that the output of the signal sends a message from which it is possible to ascertain that an emergency has arisen and/or such that the signal is an audio or visual signal.

Depending on the situation into which a user who may be encountering an emergency gets himself, the user can set up the communication terminal, so that when an emergency sequence is triggered when the operating element is operated, a voice link is set up or a message is sent or an audio or visual signal is output. Illustratively, the user can thus create a user profile which specifies an appropriate emergency sequence. By way of example, a skier could set up the communication terminal such that triggering an emergency sequence prompts the output of an audio signal which makes it possible to locate the skier when he has been buried by an avalanche, for example. Using different signals, it is possible to create a multiplicity of different user profiles.

The signal can also be used to send additional information. If the communication terminal is being operated in a vehicle, for example, then diagnostic data relating to a malfunction (for example in the engine), for example, can be sent. In addition, the signal may be a visual signal and may be used to transmit a Morse code. Accordingly, the communication terminal may also be set up to display received Morse signals using a display apparatus.

The signal may also be in a form such that accessories coupled to the communication terminal can be controlled and interfaces in the communication terminal can be actuated. By way of example, a specific operating panel could be used to allow Braille code to be received and sent. In addition, the signal could control a siren coupled to the communication terminal such that an appropriate audio signal is output.

These additional options may be provided at any time, and during an emergency sequence it is possible to use any functions of the communication terminal.

It is also preferred for the message to be a text message or a multimedia message.

Preferably, the message is an SMS message or an MMS message.

It is also preferred for the external triggering apparatus to be an accessory of the communication terminal.

It is also preferred for the signal output device to be a mobile radio transmission device.

Preferably, the communication terminal is a mobile radio user terminal.

In one embodiment the communication terminal comprises a detection device which is adapted to detect if the accessory is coupled with the communication terminal.

The control device is in one embodiment adapted to control the signal generation device and the signal output device in such a way that the signal generation device generates the signal which is output by the signal output device if the accessory is coupled to the communication terminal when the communication terminal is switched on and/or if the communication terminal is switched on and the accessory is separated from the communication terminal.

It is also preferred for the triggering apparatus to be a chip card, a memory stick or a computer expansion card.

Preferably, the triggering apparatus is a MultiMediaCard, a USB stick or a PCMCIA (Personal Computer Memory Card International Association) card.

Preferably, the triggering apparatus can be coupled to the communication terminal using an appropriate access apparatus.

Illustratively, the accessory can also be coupled indirectly with the communication terminal.

If the triggering apparatus is in the form of a MultimediaCard, for example, then the MultiMediaCard is coupled using a card reading apparatus integrated in the communication terminal, for example, this means that the MultiMediaCard is inserted into the card reading apparatus and is coupled to the communication terminal in this way. The card reading apparatus may also be provided externally and may also be coupled to the communication terminal wirelessly, for example by means of a Bluetooth interface.

Corresponding to the form of the triggering apparatus, the access apparatus is a card reader, a USB stick reading/writing apparatus or an apparatus which has a PCMCIA card slot and allows access to an inserted PCMCIA card, for example. The access apparatus may be able to be coupled to the communication terminal externally or may be integrated in the communication terminal.

The use of a card reading apparatus or another access apparatus produces a further cost advantage, since an access apparatus is typically a standard component in a communication terminal.

Illustratively, a mobile radio user terminal (or another mobile platform), for example, which allows the use of and access to MultiMediaCards, is expanded by using a special MultiMediaCard, for example as described below, so that the mobile radio user terminal has an advanced emergency call functionality.

Using different access apparatuses, chip cards, memory sticks and expansion cards, it is possible to implement a multiplicity of embodiments of the invention.

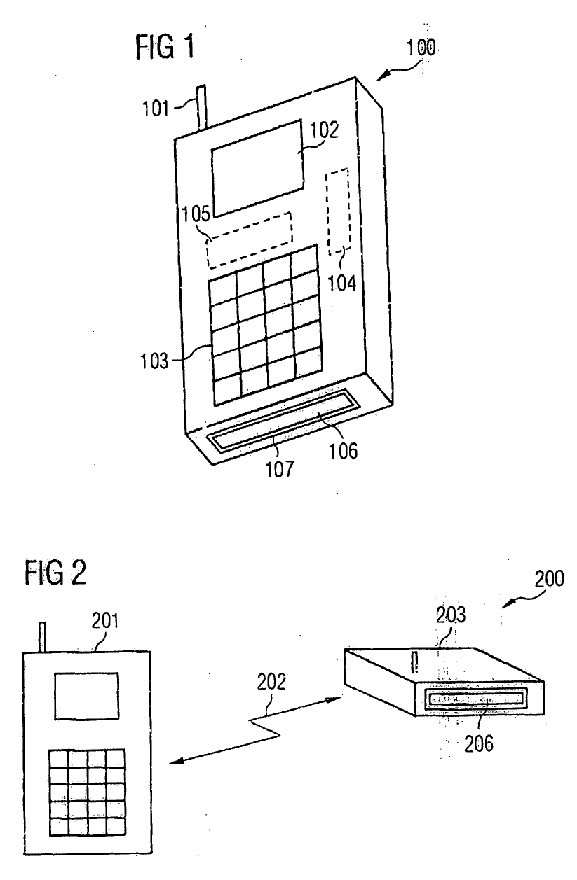

FIG. 1 shows a mobile radio user terminal 100 based on an exemplary embodiment of the invention.

The mobile radio user terminal 100 has an antenna 101, a display device 102 and an operating panel 103.

In addition, the mobile radio user terminal 100 has a data processing device 104 and a memory 105, which are shown in dashes in FIG. 1 since they are not visible from the outside.

In this exemplary embodiment, a triggering element, that is to say an operating element for triggering an emergency call, is mounted on a memory chip card 106 which is inserted in an appropriate chip card reading apparatus 107 in the mobile radio user terminal 100.

The mobile radio user terminal 100 is set up and configured on the basis of the GSM (Global System for Mobile Communications) standard or on the basis of the UMTS (Universal Mobile Telecommunications System) standard for example.

In this example, the memory chip card 106 is a MultiMediaCard (MMC).

FIG. 2 shows a communication arrangement 200 based on an exemplary embodiment of the invention.

The communication arrangement 200 has a mobile radio user terminal 201 which is set up and configured in similar fashion to FIG. 1, but in this case there is no memory chip card 106 and no internal chip card reading apparatus 107 in the mobile radio user terminal 201, but rather the mobile radio user terminal 201 is coupled to an external chip card reading apparatus 203 by means of a radio interface 202. By way of example the mobile radio user terminal 201 and the chip card reading apparatus 203 are coupled to one another by means of a Bluetooth interface and have corresponding transmission/reception devices.

The chip card reading apparatus 203 has a memory chip card 206 inserted into it which is configured in line with the memory chip card 106.

One possible configuration of the memory chip card 106, 206 is explained below.

FIG. 3 shows a memory chip card 300 based on an exemplary embodiment of the invention.

In this example, the memory chip card 300 is configured in line with the standard for MultiMediaCards (MMCs) and is shown in FIG. 3 from below.

MultiMediaCards are very popular and widespread within the context of mobile applications and are used as small removable flash memory apparatuses in mobile radio user terminals, for example. A MultiMediaCard has the form 32 mm×24 mm and a thickness of 1.4 mm.

In line with the MultiMediaCard standard, the memory chip card 300 has seven electrical interface contacts 301 to 307, with a first contact 301 being labeled RSV, not being connected and, in line with the MultiMediaCard standard, always having the logic value 1 applied to it, a second contact 302 being labeled CMD and, in line with the MultiMediaCard standard, being used for instructions and response signals, a third contact being labeled VSS1 and, in line with the MultiMediaCard standard, having the grounding system of the power supply for the memory chip card 300 applied to it, a fourth connection 304 being labeled VDD and, in line with the MultiMediaCard standard, being used for supplying power to the memory chip card 300, a fifth connection 305 being labeled CLK and, in line with the MultiMediaCard standard, being able to be used to provide a clock signal, a sixth connection being labeled VSS2 and, in line with the MultiMediaCard standard, being able to have the grounding system of the power supply applied to it, and a seventh connection 307 being labeled DAT[0] and being a data connection.

The electrical interface contacts 301 to 307 are standardized, as mentioned, and provide an interface for the power supply, the grounding system of the power supply and for a data signal. A more precise description of the MultiMediaCard specification can be found in MultiMediaCard Product Manual Rev. 5.2, San Disk Corporation, 2002/2003.

FIG. 3 illustrates how a triggering circuit for triggering an emergency call on the basis of the MultiMediaCard interface, that is to say on the basis of the seven electrical interface contacts 301 to 307, can be implemented.

The memory chip card 300 has a switching element 308 and a resistor 309. The seventh contact 307, which, as mentioned, is a data input, is held approximately at the voltage level VDD, that is to say at the voltage level of the power supply, which corresponds to the logic state H, when the switching element 308 is in an open position, which illustratively corresponds to the state of the memory chip card 300 in which it is ready for the triggering of an emergency.

When a triggering element 310 is operated, an example of which is provided further below, the switching element 308 is closed, which applies the grounding voltage level to the seventh contact 307 on account of the coupling to the third contact 303 which has now taken place, which corresponds to the logic state L, and illustratively corresponds to the state of the memory chip card 300 in which the triggering mechanism is activated for triggering an emergency call.

In another embodiment, the function of the switching element 308 could be reversed, that is to say that the open state of the switching element 308 might illustratively correspond to activation of the triggering mechanism, and the closed state of the switching element 308 might correspond to waiting for an emergency call to be triggered, that is to say might correspond to the state of the memory chip card 300 in which the memory chip card is ready for the triggering of an emergency call.

Activating the switching element 308 (depending on the embodiment, closing or opening of the switching element 308) when the triggering element 310 is operated produces a trigger signal (in this example by applying the grounding voltage level to the seventh contact 307) and prompts it to be detected by means of a detection device, for example a piece of driver software in the mobile radio user terminal, which then executes prescribed procedures or algorithms.

For example, in response to the trigger signal a program stored in the memory 105 of the mobile radio user terminal 100 could be executed by means of the processing unit 104, so that the mobile radio user terminal is controlled such that an automatic emergency call is sent by means of the antenna 101 or a voice communication link is set up to an emergency call center.

The text below describes one possible configuration of the memory chip card 300.

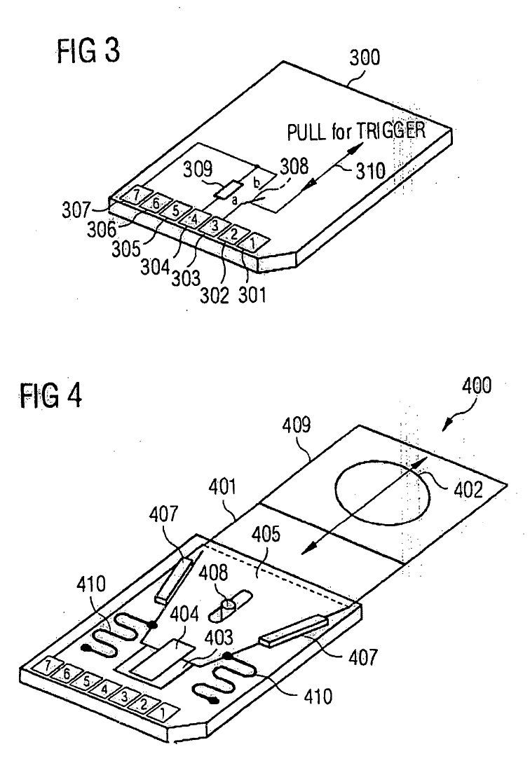

FIG. 4 shows a memory chip card 400 based on an exemplary embodiment of the invention.

In this example, the triggering element 310 for activating the switching element 308 and for controlling the electrical interface in the memory chip card 400 is in the form of a triggering grip 401. The triggering grip 401 has an operating section 409, which is illustratively that part of the triggering grip 401 which is situated outside of the housing of the memory chip card 400 and is used to operate the triggering grip 401. The size and shape of the operating section 409 are chosen such that simple accessibility and simple operation of the triggering grip 401 are ensured in any situation.

In this example, the operating section 409 has the approximate size 22 mm×20 mm, which corresponds to a surface area of 440 mm². This is approximately nine times the size of a typical (“normal”) key on a mobile radio user terminal, which typically has a key surface area of approximately 50 mm².

To allow simpler operation, the triggering grip 401 has a gripping hole 402. The operating section 409 can be made of a semiflexible material.

The triggering grip 401 is thus a three-dimensional operating element, whereas in contrast thereto conventional keys on a mobile radio user terminal, for example the keys in the operating panel 103, are two-dimensional operating elements.

In this example, the switching element 308 has a first electrical contact 403 and a second electrical contact 404.

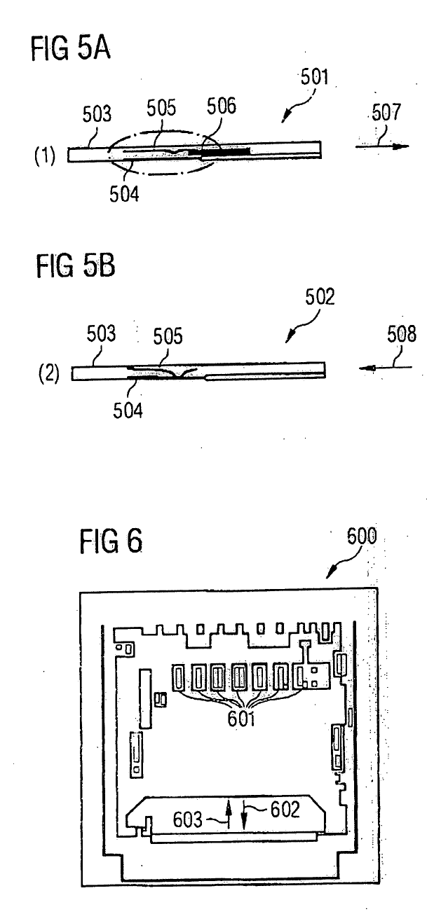

The way in which the switching element 308 configured in this manner works is explained below with reference to FIG. 4, FIG. 5a and FIG. 5b.

FIG. 5a and FIG. 5b show a switching element in a first state 501 and in a second state 502 based on an exemplary embodiment of the invention.

FIG. 5a and FIG. 5b show the cross section 503 through the memory chip card 400. In the first state 501, a first electrical contact 504, which corresponds to the first electrical contact 403, and a second electrical contact 505, which corresponds to the second electrical contact 404, are isolated from one another by an isolating element 506, which corresponds to an isolating element 405, and are electrically insulated in this way.

When an emergency call is triggered by pulling on the triggering grip 401, the isolating element 506 moves in a first direction 507, illustratively away from the memory chip card 400. When the triggering grip 401 has been pulled, the memory chip card 400 is in the second state 502. In this case, the first electrical contact 504 and the second electrical contact 505 are closed, which generates a trigger signal.

When the triggering grip is released, the triggering grip 401 and the isolating element 506 are moved in a second direction 508 by a meandrous spring system 410 with a shallow profile, illustratively toward the memory card 400, and the memory chip card 400 returns to the first state 501. In this case, the system can be activated again, that is to say that it is possible to pull on the triggering grip 401 again in order to trigger an emergency call.

The memory chip card 400 also has guide elements 407 and a position limiting element 408. The guide elements 407 form a guide for the triggering grip 401, and the position limiting element 408 is used to prevent the triggering grip 401 from being pulled out of the memory chip card 400 completely.

In the case of an embodiment in which a single application is envisaged, the position limiting element 408 may be fragile or may not be present.

As mentioned, the memory chip card 400 is arranged in the chip card reading apparatus 107, for example, which is provided in the mobile radio user terminal 100. The text below explains one possible configuration of the chip card reading apparatus 107.

FIG. 6 shows a chip card reader 600 based on an exemplary embodiment of the invention.

The chip card reader (chip card reading apparatus) 600 has a “push-and-eject function”, that is to say that, illustratively, by briefly pushing in a chip card inserted into the chip card reader 600 further it is possible to remove said chip card.

The chip card reader 600 has a plurality of spring contacts 601 which normally exert a sufficient force on an inserted memory chip card to prevent the memory chip card from unintentionally falling out of the chip card reader 600, provided that no external force is exerted on a memory chip card inserted into the chip card reader 600 in a first direction 602.

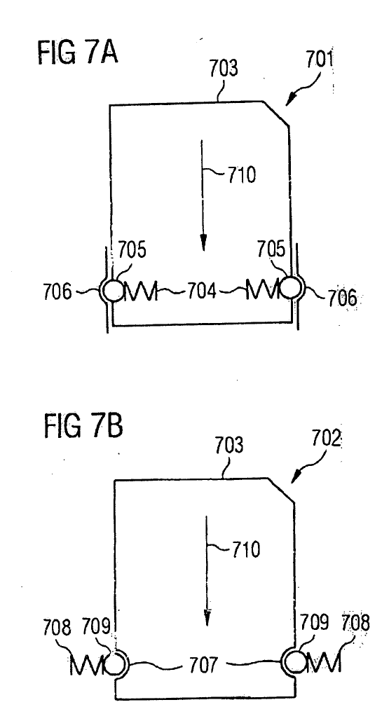

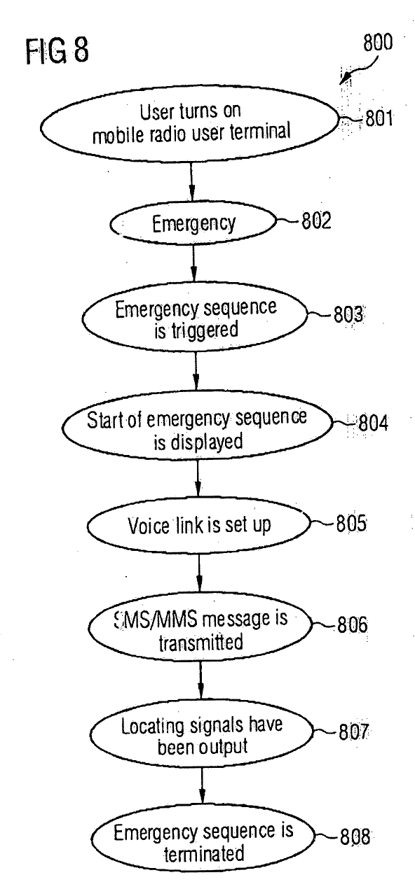

A memory chip card is inserted into the chip card reader 600 in a second direction 603. Once the memory chip card 400 configured in line with FIG. 4 has been inserted into the chip card reader 600 so that the triggering grip 401 illustratively projects from the chip card reader in appropriate fashion (downward in FIG. 6), operating the triggering grip 401 exerts a force on the memory chip card 400 in the first direction 602. To prevent the memory chip card 400 from being pulled out of the chip card reader 600 when the triggering grip 401 is operated, this exemplary embodiment has a retaining system on the memory chip card 400 or on the chip card reader 600. Possible configurations of a retaining system are explained below with reference to FIG. 7a and FIG. 7b.

FIG. 7a and FIG. 7b show retaining systems 701, 702 based on exemplary embodiments of the invention.

In FIG. 7a and FIG. 7b, a respective memory chip card 703 has been pushed fully into a chip card reader (not shown).

In the case of the retaining system 701 shown in FIG. 7a, the memory chip card 703 has two springs 704 which respectively push a mating piece 705 of a retaining cutout 706 into the respective retaining cutout 706 when the memory chip card 703 has been inserted fully into the chip card reader. The retaining cutouts 706 are provided in the chip card reader.

When the memory chip card 703 is pulled out of the chip card reader in the direction of the arrow 710, the mating pieces 705 are moved counter to the action of the springs 704 from their position in the retaining cutouts, which increases the force required to pull the memory chip card 703 out of the chip card reader.

The force which is required to pull the memory chip card 703 out of the chip card reader, which force corresponds to the force with which the memory chip card 703 is held in the chip card reader, is determined by the strength of the springs 704 and by the shape of the retaining cutouts 706.

A configuration based on FIG. 4A has the advantage that only the chip card reader has retaining cutouts, and hence normally configured memory chip cards can be used with the chip card reader. In the case of the retaining system shown in FIG. 7b, retaining cutouts 707 are provided on the memory chip card 703. Springs 708 and mating pieces 709 for the retaining cutouts 707 are accordingly provided on the chip card reader. The operation of the retaining system 702 is similar to the operation of the retaining system 701.

The modifications which are required on standard memory chip cards and standard chip card readers in order to implement retaining systems 701, 702 as shown in FIG. 7a or FIG. 7b are slight and barely increase the price of the respective component. It is therefore possible to configure all kinds of chip card readers in line with one of the retaining systems 701, 702 inexpensively, so that there is always the possibility of inserting a memory chip card with a triggering grip, for example as shown in FIG. 4, into the chip card reader and of using it.

It is not just possible to implement an external triggering functionality for triggering an emergency call using a MultiMediaCard, as described above, but rather said external triggering functionality can likewise easily be integrated into other kinds of chip cards, such as into a PCMCIA (Personal Computer Memory Card International Association) card or into a USB (Universal Serial Bus) stick. It is thus possible to implement an external triggering functionality as part of almost all modern mobile radio user terminals and other mobile platforms, since these typically have at least one interface for a chip card or a memory stick.

In more complex implementations, a triggering grip can be provided, for example, and at the same time the “actual” central function of the respective chip card can be provided. This is to be understood to mean that, by way of example, a memory chip card which can be used to store data, for example a flash memory chip card, is additionally equipped with a triggering grip as shown in FIG. 4, that is to say the triggering functionality is provided in addition to the central function, in this example, the function is a memory.

The state of the triggering grip, that is to say the test for whether or not the triggering grip has been operated, could be signaled via the interface by means of which the central function of the memory chip card is used, for example using time division multiplexing.

Instead of providing a first electrical contact 403 and a second electrical contact 404 in line with FIG. 4, a switching element could be refined by means of a sensor, so that the number of discrete parts is reduced. Accordingly, the first electrical contact 403 and the second electrical contact 404 could be made of a corrosion-resistant material, which would increase security but would also increase the costs of the memory chip card in question.

In the case of the implementation shown in FIG. 4, the triggering grip 401 and the electrical interface, which in this example is configured in line with the MultiMediaCard standard, are integrated in an individual unit, namely the memory chip card 400. In another embodiment, a triggering grip and a corresponding switching element are arranged completely outside of the memory chip card and are coupled to the memory chip card by means of a wired connection or a wireless connection. This allows an emergency call to be triggered over a longer distance.

In one embodiment, the chip card reader is equipped with additional contact springs and the memory chip card is equipped with corresponding contacts, so that additional functionalities, such as a single-wire control bus and the check to determine whether the memory chip card has been inserted into the chip card reader (presence contact), are provided.

These functionalities are easy to provide without altering the memory chip card, when the memory chip card is configured in line with the MultiMediaCard standard, such that the compatibility with the MultiMediaCard standard is lost.

In other embodiments, retaining systems of various kinds (spring-based, springless, etc.) are in the form of a fixed part of the housing of a mobile radio user terminal or in the form of snap-on cover apparatuses, that is to say illustratively in the form of apparatuses which are fitted on the housing of the mobile radio user terminal and in which (or on which) a memory chip card can be latched.

These embodiments are less flexible, however, since the details of the refinement are typically very specific and need to be taken into account from the start during the mechanical design of the respective mobile radio user terminal and typically cannot be used for other models of mobile radio user terminals. Similar restrictions exist for embodiments in which the external triggering functionality is provided by means of mobile radio user terminal accessories which are coupled to the mobile radio user terminal by means of a special system connection, that is to say by means of a special interface.

The text below explains the use of a mobile radio user terminal which is equipped with a triggering element for triggering an emergency call.

FIG. 8 shows a flowchart 800 based on an exemplary embodiment of the invention.

For a large number of different applications based on emergency calls, it is possible to define suitable user profiles in which a suitable combination of voice communication links, communication services for exchanging information, visual and/or audio signaling for an emergency call is provided.

In addition, a user can stipulate suitable timer settings, for example can define a delay period as in the example below, and can thus produce a user profile suited to his situation, for example if he is undertaking a mountain tour.

The sequence shown in FIG. 8 illustrates an example of application which is suitable for a user who is a member of a group of skiers or snowboarders in the mountains, for example.

It is assumed that the user is carrying a mobile radio user terminal with him which has the form shown in FIG. 1, for example, and is equipped with a MultiMediaCard which has a triggering element, for example as described above with reference to FIG. 4.

In step 801, the user turns on the mobile radio user terminal.

In step 802, an emergency occurs.

In step 803, the user activates the triggering element, for example by pulling a triggering grip. Accordingly, a trigger signal is detected by means of the MultiMediaCard interface and an emergency sequence is accordingly performed by the mobile radio user terminal, for example by a program executed on the mobile radio user terminal.

In another embodiment, the emergency sequence is started when the user does not operate the triggering element on a regular basis (“dead man recognition”). This method could also be used to check the quality with which transmission and reception is possible using the mobile radio user terminal and using a corresponding mobile radio communication network. By way of example, the mobile radio user terminal could output a warning signal if the quality drops below a prescribed limit. This method might be preferred by the provider of the mobile radio communication network, since this means that the mobile radio communication network is used for transmission more often than when a message is sent or a voice communication link is set up only in an emergency.

In step 804, visual and/or audio signals are used to indicate that the emergency sequence has been triggered and appropriate measures are being taken after a certain interval of time, for example a few seconds' delay period. By way of example, the user might have stipulated the time delay defined by the delay period to be 10 seconds. During the delay period, the user can stop the emergency sequence manually, for example if the triggering element has been operated unintentionally.

In one embodiment, manually stopping the emergency sequence is protected by means of a PIN code, that is to say that it is necessary to input a PIN code in order to be able to stop the emergency sequence manually.

In step 805, after the delay period has elapsed, a voice link to a prescribed telephone number is set up. Setting up the voice link connects the user to an emergency service, for example on telephone number 112 in Europe or 911 in the USA, to a route service, to a mountain rescue station or to a private contact who assesses the situation and contacts a third party if required. If it is not possible to set up a voice link to the prescribed telephone number, for example because the number is busy and a busy signal is received, an attempt is made to set up a voice link using an (or a plurality of) alternative telephone number.

In step 806, a prescribed SMS (Short Message Service) message or an MMS (Multimedia Message Service) message is additionally sent as part of the emergency sequence. This allows the user to communicate fundamental data and up-to-date data about the situation automatically in a short time without interruption. Fundamental data might include the number of people traveling, for example, the number of members of a mountain climbing group, for example, personal data and other details, for example medical characteristics, such as intolerance to particular medicaments. The fundamental data also allow the user to request particular services and actions, for example a return call. The up-to-date data may include the local position, the ambient temperature and the personal condition of the user, for example information from a pulse measuring unit.

In step 807, the mobile radio user terminal repeatedly sends signals as part of the emergency sequence in order to simplify locating the user. These may be audio and visual signals and also signals which are output by means of the mobile radio communication network used, or signals which are independent of the mobile radio communication network and are transmitted by means of other communication systems which allow wireless communication, for example signals transmitted via the mobile radio user terminal using a Bluetooth interface.

Audio and visual signals are particularly suitable in the case of an avalanche accident or an emergency which occurs in the night, for example. Signals can be generated in line with a prescribed flowchart, for example alternately, continuously or in separate pulses, so that a long operating time is achieved, for example so that power consumption of the mobile radio user terminal is low, so that the storage battery in the mobile radio user terminal fails to supply any more power only after a long period.

In step 808, the emergency sequence is terminated after the emergency situation has been resolved.

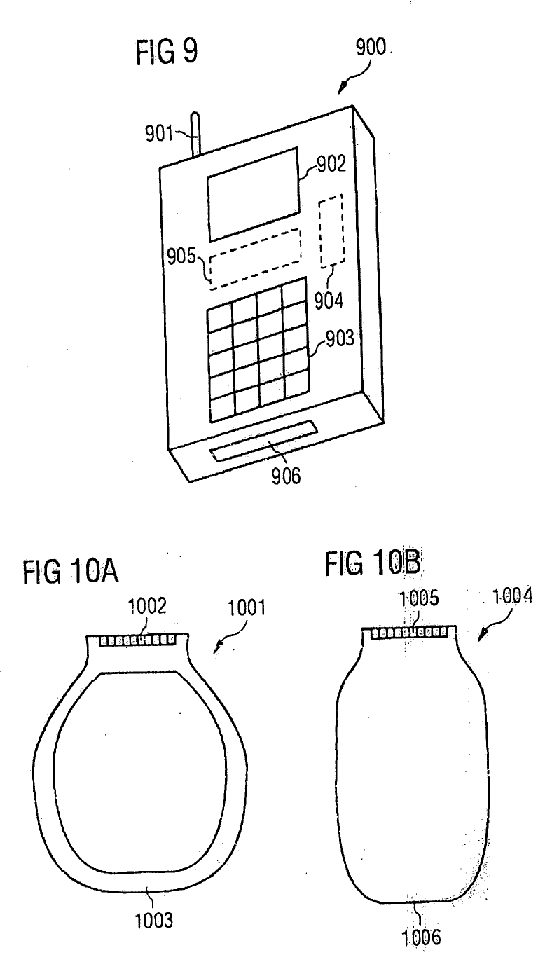

FIG. 9 shows a mobile radio user terminal 900 based on an exemplary embodiment of the invention. Similar to the mobile radio user terminal 100 of FIG. 1, the mobile radio user terminal 900 has an antenna 901, a display device 902 and an operating panel 903. In addition, the mobile radio user terminal 900 has a data processing device 904 and a memory 905, which are shown in dashes in FIG. 1 since they are not visible from the outside.

The mobile radio user terminal 900 further comprises an interface 906 by a which an accessory (not shown) can be coupled to the mobile radio user terminal 900.

The mobile radio user terminal 900 is set up and configured according to the GSM (Global System for Mobile Communications) standard or according to the UMTS (Universal Mobile Telecommunications System) standard for example.

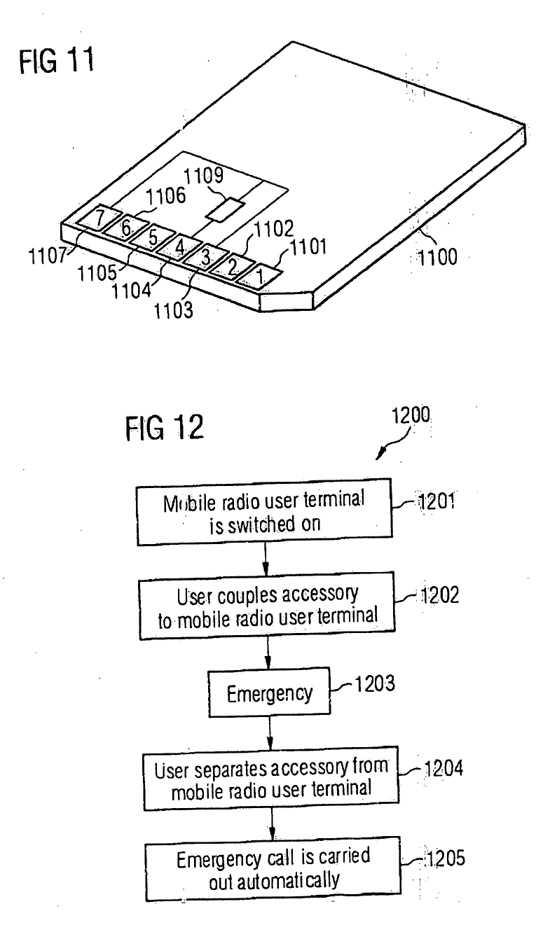

In the following, examples for accessories which can be coupled to the mobile radio user terminal 900 by the interface 906 are described with reference to FIG. 10(a), FIG. 10(b) and FIG. 11.

FIG. 10(a) shows an accessory 1001 based on an exemplary embodiment of the invention.

The accessory 1001 comprises an interface 1002 which is in this embodiment formed as a plug connection 1002.

The accessory 1001 mainly consists of a ring (or a loop) 1003 by which the accessory 1001 when it is plugged into the mobile radio user terminal 900 can be separated from the mobile radio user terminal 900 by the user of the mobile radio user terminal 900 in a simple way and under difficult circumstances, for example when the user is wearing thick gloves.

The mobile radio user terminal 900 is in this example provided with a software which allows the mobile radio user terminal 900 to detect, if the accessory 1001 is coupled to the mobile radio user terminal 900. For this, for example, two connections of the interface 1002 may be short-circuited which, when the accessory 1001 is coupled to the mobile radio user terminal 900 make a short circuit of the corresponding connections of the interface 906 and the mobile radio user terminal 900 can detect that these corresponding connections are no longer short circuited when the accessory 1001 is separated from the mobile radio user terminal 900.

As will be detailed below, the mobile radio user terminal 900 automatically sends an emergency call when it is detected that the accessory 1001 is separated from the mobile radio user terminal 900.

An example for a further accessory which can be used analogously to the accessory 1001 in combination with the mobile radio user terminal 900 is illustrated in FIG. 10(b).

FIG. 10(b) shows an accessory 1004 which is based on an exemplary embodiment of the invention.

Analogously to the accessory 1001 shown in FIG. 10(a), the accessory 1004 comprises an interface (plug connection) 1005 by which the accessory 1004 can be coupled with the mobile radio user terminal 900.

However, the accessory 1004 has not the form of a ring 1003, but has the form of a flexible small plate 1006.

Illustratively, the user of the mobile radio user terminal 900 can separate the accessory 1004 from the mobile radio user terminal 900 by achieving, by means of pressing the flexible small plate 1006, whereby the flexible small plate 1006 is bent, that the interface 1005 “springs out” of the interface 906.

Illustratively, the accessory 1004 is separated from the mobile radio user terminal 900 by bending the ensemble consisting of the mobile radio user terminal 900 and the accessory 1004.

A further example for an accessory is described with reference to FIG. 11 in the following.

FIG. 11 is a memory chip card 1100 based on an exemplary embodiment of the invention.

In this example, the memory chip card 1100 is the accessory and it is formed according to the standard for MultiMediaCards (MMCs). The memory chip card 1100 is shown in FIG. 11 from below.

MultiMediaCards are very popular and widespread within the context of mobile applications and are used as small removable flash memory apparatuses in mobile radio user terminals, for example. A MultiMediaCard has the form 32 mm×24 mm and a thickness of 1.4 mm.

In line with the MultiMediaCard standard, the memory chip card 1100 has seven electrical interface contacts 1101 to 1107, with a first contact 1101 being labeled RSV, not being connected and, in line with the MultiMediaCard standard, always having the logic value 1 applied to it, a second contact 1102 being labeled CMD and, in line with the MultiMediaCard standard, being used for instructions and response signals, a third contact being labeled VSS1 and, in line with the MultiMediaCard standard, having the grounding system of the power supply for the memory chip card 1100 applied to it, a fourth connection 1104 being labeled VDD and, in line with the MultiMediaCard standard, being used for supplying power to the memory chip card 1100, a fifth connection 1105 being labeled CLK and, in line with the MultiMediacard standard, being able to be used to provide a clock signal, a sixth connection being labeled VSS2 and, in line with the MultiMediaCard standard, being able to have the grounding system of the power supply applied to it, and a seventh connection 1107 being labeled DAT[0] and being a data connection. The memory chip card 1100 also has a resistro 1109 connected between fourth connection 1104 and seventh connection 1107 and third connection 1103.

The electrical interface contacts 1101 to 1107 are standardized, as mentioned, and provide an interface for the power supply, the grounding system of the power supply and for a data signal. A more precise description of the MultiMediaCard specification can be found in MultiMediaCard Product Manual Rev. 5.2, San Disk Corporation, 2002/2003.

FIG. 11 illustrates in which way it can be realized on basis of the MultiMediacard interface, i.e. on basis of the seven electrical interface contacts 1101 to 1107, that the mobile radio user terminal 900 can detect if the memory chip card 1100 is coupled with the mobile radio user terminal 900. Correspondingly, it is assumed in the following that the interface 906 is an interface for coupling the memory chip card 1100, for example, the mobile radio user terminal 900 comprises a corresponding card reader.

When the memory chip card 1100 is coupled with the mobile radio user terminal 900, because of the coupling to the third contact 1103 which has now taken place, the seventh contact 1107 is now coupled with grounding voltage level, which corresponds to the logical state L and which can be detected by the mobile radio user terminal 900. When the memory chip card 1100 is separated from the mobile radio user terminal 900 the seventh contat 1107 is no longer connected to grounding voltage level which can also be detected by the mobile radio user terminal 900.

The detection can be carried out by a driver software in the mobile radio user terminal which driver software thereupon carries out predetermined procedures or algorithms.

For example, as a reaction to the triggering signal, a program stored in the memory 905 of the mobile radio user terminal 900 could be executed by the data processing device such that the mobile radio user terminal 900 is controlled in such a way that an automatic emergency call is sent by means of the antenna 901 or a voice communication connection to an emergency center is established.

An example for a corresponding flow is described in the following.

FIG. 12 shows a flow diagram 1200 which is based on an exemplary embodiment of the invention.

In step 1201 the user of the mobile radio user terminal 900 switches on the mobile radio user terminal 900.

The accessory is for example one of the accessories shown in FIG. 10(a), FIG. 10(b) and FIG. 11.

The accessory has a unique identification which allows a software executed on the mobile radio user terminal 900 to detect that the accessory is now coupled with the mobile radio user terminal.

After it has been detected that the accessory is coupled to the mobile radio user terminal 900, the software executes an application on the mobile radio user temrinal 900 which illustratively runs in the background. This application can be stopped by the user, for example by means of the control panel 903 or other input devices. Now, it is assumed that the application is not stopped.

In step 1203 an emergency occurs.

The user therefore separates the accessory from the mobile user terminal 900 in step 1204.

The software executed on the mobile radio user terminal 900 or the application executed on the mobile radio user terminal 900 detects that the accessory has now been separated from the mobile radio user terminal 900. Thereupon, the application automatically carries out an emergency call in step 1205.

In the case that the user has stopped the application no emergency call is carried out when the accessory is separated from the mobile user terminal 900.

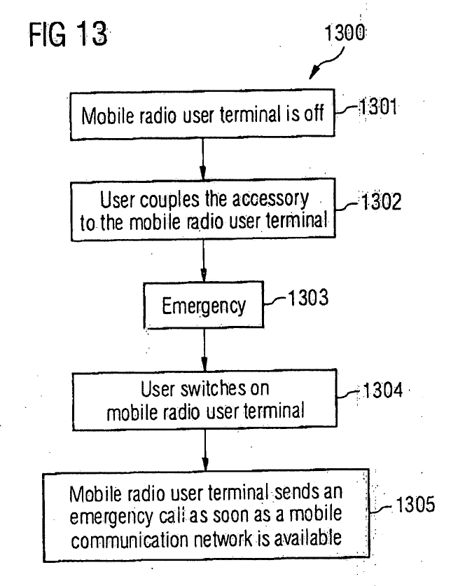

A flow according to a further embodiment of the invention is described in the following with reference to FIG. 13.

FIG. 13 shows a flowchart 1300 based on an exemplary embodiment of the invention.

It is assumed that the mobile radio user terminal is switched off in step 1301.

In step 1302 the user couples the accessory, for example one of the accessories shown in FIG. 10(a), FIG. 10(b) and FIG. 11, with the mobile radio user terminal 900.

In step 1303 an emergency occurs.

Thereupon, the user of the mobile radio user terminal 900 switches the mobile radio user terminal 900 on.

In this embodiment, in contrast to the embodiment described above, the mobile radio user terminal 900 detects that an emergency has occurred by detecting that the accessory is coupled to the mobile radio user terminal and not, that the accessory has been separated from the mobile radio user terminal 900.

Correspondingly, it is advantageously in one embodiment when the accessory can be coupled to the mobile radio user terminal 900 in an easy way.

In step 1305 the mobile radio user terminal starts and detects that the emergency functionality has been activated by detecting that the accessory is coupled to the mobile radio user terminal 900. The mobile radio user terminal 900 now searches for available mobile communication networks.

As soon as a mobile communication network is available, the mobile radio user terminal 900 automatically carries out an emergency.

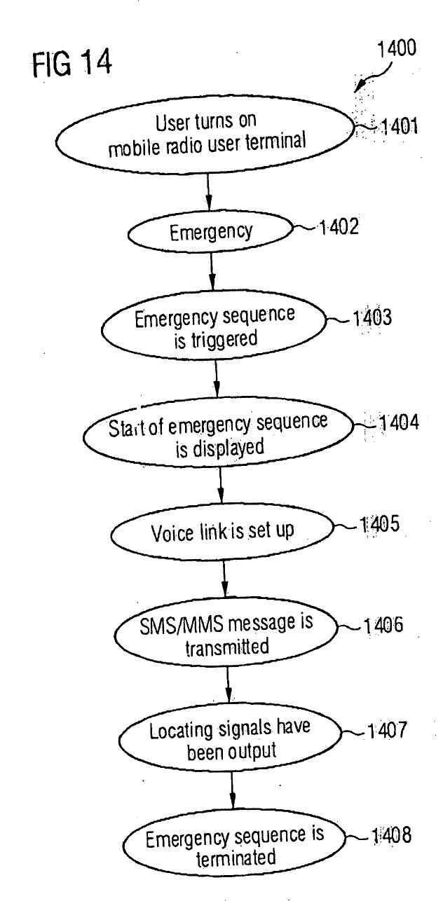

A further example for a flow is described in the following with reference to FIG. 14.

FIG. 14 shows a flowchart based on an exemplary embodiment of the invention.

For a large number of different applications based on emergency calls, it is possible to define suitable user profiles in which a suitable combination of voice communication links, communication services for exchanging information, visual and/or audio signaling for an emergency call is provided.

In addition, a user can stipulate suitable timer settings, for example can define a delay period as in the example below, and can thus produce a user profile suited to his situation, for example if he is undertaking a mountain tour.

The sequence shown in FIG. 14 illustrates an example of application which is suitable for a user who is a member of a group of skiers or snowboarders in the mountains, for example.

It is assumed that the user is carrying a mobile radio user terminal 900 and a suitable accessory, for example one of the accessories shown in FIG. 10(a), FIG. 10(b) and FIG. 11 with him.

In step 1401, the user turns on the mobile radio user terminal 900 and couples the accessory to the mobile radio user terminal 900.

In step 1402, an emergency occurs.

In step 1403 the user sparates the accessory from the mobile radio user terminal 900 for example by pulling it out of the mobile radio user terminal 900. This is correspondingly detected by the mobile radio user terminal 900 by means of the interface 906 und correspondingly, an emergency sequence is carried out by the mobile radio user terminal 900, for example by a program executed on the mobile radio user terminal 900.

In step 1404, visual and/or audio signals are used to indicate that the emergency sequence has been triggered and appropriate measures are being taken after a certain interval of time, for example a few seconds' delay period. By way of example, the user might have stipulated the time delay defined by the delay period to be 10 seconds. During the delay period, the user can stop the emergency sequence manually, for example if the accessory has been separated from the mobile radio user terminal unintentionally.

In one embodiment, manually stopping the emergency sequence is protected by means of a PIN code, that is to say that it is necessary to input a PIN code in order to be able to stop the emergency sequence manually.

In step 1405, after the delay period has elapsed, a voice link to a prescribed telephone number is set up. Setting up the voice link connects the user to an emergency service, for example on telephone number 112 in Europe or 911 in the USA, to a route service, to a mountain rescue station or to a private contact who assesses the situation and contacts a third party if required. If it is not possible to set up a voice link to the prescribed telephone number, for example because the number is busy and a busy signal is received, an attempt is made to set up a voice link using an (or a plurality of) alternative telephone number.

In step 1406, a prescribed SMS (Short Message Service) message or an MMS (Multimedia Message Service) message is additionally sent as part of the emergency sequence. This allows the user to communicate fundamental data and up-to-date data about the situation automatically in a short time without interruption. Fundamental data might include the number of people traveling, for example, the number of members of a mountain climbing group, for example, personal data and other details, for example medical characteristics, such as intolerance to particular medicaments. The fundamental data also allow the user to request particular services and actions, for example a return call. The up-to-date data may include the local position, the ambient temperature and the personal condition of the user, for example information from a pulse measuring unit.

In step 1407, the mobile radio user terminal repeatedly sends signals as part of the emergency sequence in order to simplify locating the user. These may be audio and visual signals and also signals which are output by means of the mobile radio communication network used, or signals which are independent of the mobile radio communication network and are transmitted by means of other communication systems which allow wireless communication, for example signals transmitted via the mobile radio user terminal using a Bluetooth interface.

Audio and visual signals are particularly suitable in the case of an avalanche accident or an emergency which occurs in the night, for example. Signals can be generated in line with a prescribed flowchart, for example alternately, continuously or in separate pulses, so that a long operating time is achieved, for example so that power consumption of the mobile radio user terminal is low, so that the storage battery in the mobile radio user terminal fails to supply any more power only after a long period.

In step 1408, the emergency sequence is terminated after the emergency situation has been resolved.

What is claimed is:

1. A communication terminal comprising:
an external triggering apparatus which has an operating element and a signaling device, which generates a trigger signal when the operating element is operated mechanically;
a signal generation device;
a signal output device;
a detection device which detects the trigger signal; and
a control device which controls the signal generation device to generate a signal which is output by the signal output device when the trigger signal is detected by the detection device.

2. The communication terminal as claimed in claim 1, wherein the signal is in a form such that output of the signal sets up a voice communication link using a telephone number from a plurality of prescribed telephone numbers and/or such that output of the signal sends a message from which it is possible to ascertain that an emergency has arisen, and/or where the signal is an audio or visual signal.

3. The communication terminal as claimed in claim 2, wherein the message is a text message or a multimedia message.

4. The communication terminal as claimed in claim 3, wherein the message is an SMS message or an MMS message.

5. The communication terminal as claimed in claim 1, wherein the external triggering apparatus is an accessory of the communication terminal.

6. The communication terminal as claimed in claim 1, wherein the signal output device is a mobile radio transmission device.

7. The communication terminal as claimed in claim 1, wherein the communication terminal is a mobile radio user terminal.

8. The communication terminal as claimed in claim 1, wherein the triggering apparatus is selected from the group consisting of a chip card, a memory stick, and a computer expansion card.

9. The communication terminal as claimed in claim 8, wherein the triggering apparatus is selected from the group consisting of a MultiMediaCard, a USB stick, and a PCMCIA card.

10. The communication terminal as claimed in claim 8, wherein the triggering apparatus can be coupled to the communication terminal using an access apparatus.

11. A method for controlling a communication terminal having a detection device, a,control device, a signal generation device and a signal output device, the method comprising the steps of:
detecting a trigger signal which is generated when an operating element in an external triggering apparatus coupled to the communication terminal is operated mechanically; and
prompting, based on the detection of the trigger signal, the communication terminal to be controlled such that the communication terminal generates and outputs a signal.

12. A communication arrangement comprising:
an triggering apparatus having an operating element and a signaling device, which generates a trigger signal when the operating element is operated mechanically; and
a communication terminal coupled with the triggering apparatus and having:
a signal generation device;
a signal output device;
a detection device which detects the trigger signal; and
a control device which controls the signal generation device to generate a signal which is output by the signal output device when the trigger signal is detected by the detection device.

13. A triggering apparatus comprising:
an operating element; and
a signaling device,
wherein the triggering apparatus can be coupled to a communication terminal, and the triggering apparatus is external relative to the communication terminal, and
wherein the signaling device generates a trigger signal when the operating element is operated mechanically, and the communication terminal generates and outputs a signal when the trigger signal is detected.

14. A computer program element which, having been loaded into a memory of a communication terminal and executed by a processor in the communication terminal, prompts the following method steps to be carried out:
detecting a trigger signal which is generated when an operating element in an external triggering apparatus coupled to the communication terminal is operated mechanically; and
prompting, based on the detection of the trigger signal, the communication terminal to be controlled such that the communication terminal generates and outputs a signal.

15. A communication terminal comprising:
a signal generation device;
a signal output device;
an accessory; and
a control device which, depending on whether the accessory is coupled in the communication terminal, controls the signal generation device to generate a signal which is output from the signal output device, indicating that an emergency has occurred.

16. Communication terminal as claimed in claim 15, further comprising a detection device which is adapted to detect if the accessory is coupled with the communication terminal.

17. Communication terminal as claimed in claim 15 wherein the control device controls the signal generation device to generate the signal which is output by the signal output device if the accessory is coupled to the communication terminal when the communication terminal is switched on or if the communication terminal is switched on and the accessory is separated from the communication terminal.

18. A method for controlling a communication terminal which can be coupled with an accessory wherein the communication terminal is controlled depending on whether the accessory is coupled with the communication terminal to generate and output a signal indicating that an emergency has occurred.

19. A communication arrangement comprising:
an accessory; and
a communication terminal coupled with the accessory and having:
a signal generation device;
a signal output device; and
a control device which controls, depending on whether the accessory is coupled with the communication terminal, the signal generation device to generate a signal which is output from the signal output device, thereby indicating that an emergency has occurred.

20. A computer program element which, having been loaded into the memory of a communication terminal which is coupled with an accessory and executed by a processor in the communication terminal, prompts that the communication terminal is controlled depending on whether the accessory is coupled with the communication terminal to generate and output a signal indicating that an emergency has occurred.

21. Computer readable storage medium on which program instructions are stored which, when executed by a processor of a communication terminal which can be coupled to an accessory prompt that the communication terminal is controlled depending on whether the accessory is coupled with the communication terminal to generate and output a signal indicating that an emergency has occurred.
